(19) United States
(12) Patent Application Publication
(10) Pub. No.: US 2005/0083030 A1
(43) Pub. Date: Apr. 21, 2005

(54) Band-gap type constant voltage generating circuit

(75) Inventors: Masahiro Ito, Kanagawa (JP); Masafumi Tatewaki, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 10/967,287

(22) Filed: Oct. 19, 2004

(30) Foreign Application Priority Data
Oct. 20, 2003 (JP) 2003-359601

(51) Int. Cl. G05F 3/16

(52) U.S. Cl. 323/315

(57) ABSTRACT

A band-gap type constant voltage generating circuit is produced in a semiconductor chip, and has a first potential terminal and a second potential terminal. A band-gap circuit includes first and second transistors having respective bases connected to each other, a first resistor connected between emitters of the first and second transistors, and a second resistor connected between the emitter of the second transistor and the first potential terminal. A constant voltage production circuit is provided between the first and second potential terminals to produce and output a constant voltage based on a base-emitter voltage of the second transistor of the band-gap circuit, and the constant voltage is fed as a feedback signal to the base of the second transistor of the band-gap circuit. A driver circuit is provided between the first and second potential terminals and connected to collectors of the first and second transistors to drive the band-gap circuit. The driver circuit is constituted such that an influence of absolute process fluctuation, to which the semiconductor chip is subjected during a production process thereof, is eliminated from the constant voltage.

### BACKGROUND OF THE INVENTION

1. Field of the Invention

The present invention generally relates to a constant voltage generating circuit, and more particularly relates to a band-gap type constant voltage generating circuit produced in a semiconductor chip.

2. Description of the Related Art

Such a band-gap type constant voltage generating circuit is constituted such that a constant voltage is output by utilizing a difference of a potential drop (which is defined as a base-emitter voltage) in a P-N junction between a base and an emitter of a bipolar junction transistor. This band-gap type constant voltage generating circuit can output the constant voltage without being substantially influenced by variation in environmental temperature.

Nevertheless, the band-gap type constant voltage generating circuit is susceptible to variation in process conditions. When a plurality of semiconductor chips, each of which has a band-gap type constant voltage generating circuit, are processed and produced in a semiconductor wafer, such as a silicon wafer, various elements forming the band-gap type constant generating circuit are subjected to both an absolute process fluctuation and a relative process fluctuation due to the variation in the process conditions.

For example, when two elements, which are identical to each other, are processed and produced in a silicon wafer at locations remotely separated from each other, a variation between the produced elements is defined as the absolute process fluctuation. On the other hand, when two elements, which are identical to each other, are processed and produced in a silicon wafer at locations closed to each other, a variation between the produced elements is defined as the relative process fluctuation. In general, the absolute process fluctuation is on the order of ±20%, and the relative process fluctuation is on the order of ±2%.

Of course, the absolute process fluctuation should be eliminated before quality and reliance of the band-gap type constant voltage generating circuits can be improved. Nevertheless, the prior art band-gap type constant voltage generating circuits fail to eliminate the absolute process fluctuation, as discussed in detail hereinafter.

### SUMMARY OF THE INVENTION

Therefore, an object of the present invention is to provide a constant voltage generating circuit produced in a semiconductor chip, which is constituted so as not to be susceptible to variation in process conditions.

In accordance with the present invention, there is provided a band-gap type constant voltage generating circuit produced in a semiconductor chip and having a first potential terminal and a second potential terminal. The band-gap type constant voltage generating circuit comprises: a band-gap circuit including first and second transistors having respective bases connected to each other, a first resistor connected between emitters of the first and second transistors, and a second resistor connected between the emitter of the second transistor and the first potential terminal; a constant voltage production circuit provided between the first and second potential terminals to produce and output a constant voltage based on a base-emitter voltage of the second transistor of the band-gap circuit, with the constant voltage being fed as a feedback signal to the base of the second transistor of the band-gap circuit; and a driver circuit provided between the first and second potential terminals and connected to collectors of the first and second transistors to drive the band-gap circuit. According to the present invention, the driver circuit is constituted such that an influence of absolute process fluctuation, to which the semiconductor chip is subjected during a production process thereof, is eliminated from the constant voltage.

The driver circuit may be formed by a current mirror circuit having an input terminal and an output terminal and connected to the first potential terminal, a first Wilson type current mirror circuit having an input terminal and an output terminal and connected to the second potential terminal, and a second Wilson type current mirror circuit having an input terminal and an output terminal and connected to the second potential terminal. The respective collectors of the first and second transistors of the band-gap circuit are connected to the input terminal of the first Wilson type current mirror circuit and the output terminal of the second Wilson type current mirror circuit, and the respective input and output terminals of the current mirror circuit are connected to the output terminal of the first Wilson type current mirror circuit and the input terminal of the second Wilson type current mirror circuit.

The current mirror circuit may include third and fourth transistors having respective bases connected to each other, a third resistor connected between the first potential terminal and an emitter of the third transistor, and a fourth resistor connected between the first potential terminal and an emitter of the fourth resistor. A collector of the third transistor forms the input terminal of the current mirror circuit, and a collector of the fourth transistor forms the output terminal of the current mirror circuit.

In this case, the constant voltage may be represented by the following equation:
V_{REF}=V_{BE}(Q₂)+[2·R₂/R₁]dV_{BE}−2 R₂·I_{C}/h_{fe}
Herein: V_{REF} is the constant voltage; V_{BE}(Q₂) is the base-emitter voltage of the second transistor; R₂ is a resistance value of the second resistor; R₁ is a resistance value of the first resistor; dV_{BE} is a difference between a base-emitter voltage of the first transistor and the base-emitter voltage of the second transistor; I_{C} is a collector current of the first, second, third and fourth transistors; and h_{fe} is a current amplification factor of the first, second, third and fourth transistors.

In this equation, the first member V_{BE}(Q₂) is subjected to the influence of absolute process fluctuation. According to the present invention, the resistance value R₂ and the collector current I_{C} are set such that the following equation is established:
V_{BE}(Q₂)=2·R₂·I_{C}/h_{fe}

Namely, the first member V_{BE}(Q₂) is removed from the first-mentioned equation, and thus it is possible to eliminate the influence of absolute process fluctuation from the constant voltage.

An emitter junction area ratio of the third and fourth transistors of the current mirror circuit may be regulated to thereby vary the coefficient of the third member R₂·I_{C}/h_{fe} of the first-mentioned equation.

In this band-gap type constant voltage generating circuit, a coefficient-determination transistor may be provided between the collector of the first transistor of the band-gap circuit and the input terminal of the first Wilson type current mirror circuit. A collector of the coefficient-determination transistor is connected to the input terminal of the first Wilson type current mirror circuit, a base of the coefficient-determination transistor is connected to the collector of the second transistor of the band-gap circuit, and an emitter of the coefficient-determination transistor is connected to the collector of the second transistor of the band-gap circuit. When the coefficient-determination transistor is used, the constant voltage is represented by the following equation:
V_{REF}=V_{BE}(Q₂)+[2·R₂/R₁]dV_{BE}−α·R₂·I_{C}/h_{fe}
Herein: V_{REF} is the constant voltage; V_{BE}(Q₂) is the base-emitter voltage of the second transistor; R₂ is a resistance value of the second resistor; R₁ is a resistance value of the first resistor; dV_{BE} is a difference between a base-emitter voltage of the first transistor and the base-emitter voltage of the second transistor; I_{C} is a collector current of the first, second, third and fourth transistors; h_{fe} is a current amplification factor of the first, second, third and fourth transistors, and α is a coefficient determined in dependence upon an emitter junction area of the coefficient-determination transistor.

In this case, the resistance value R₂ and the collector current I_{C} are set such that the following equation is established:
V_{BE}(Q₂)=α·R₂·I_{C}/h_{fe}

Namely, the first member V_{BE}(Q₂) is removed from the first-mentioned equation, and thus it is possible to eliminate the influence of absolute process fluctuation from the constant voltage.

### BRIEF DESCRIPTION OF THE DRAWINGS

The above object and other objects will be more clearly understood from the description set forth below, with reference to the accompanying drawings, wherein:

FIG. 1 is a wiring diagram of a first prior art band-gap type constant voltage generating circuit produced in a semiconductor chip;

FIG. 2 is a wiring diagram of a second prior art band-gap type constant voltage generating circuit produced in a semiconductor chip;

FIG. 3 is a wiring diagram of a first embodiment of a band-gap type constant voltage generating circuit according to the present invention;

FIG. 4 is a wiring diagram of a second embodiment of the band-gap type constant voltage generating circuit according to the present invention; and

FIG. 5 is a wiring diagram of a third embodiment of a band-gap type constant voltage generating circuit according to the present invention.

### DESCRIPTION OF THE PREFERRED EMBODIMENTS

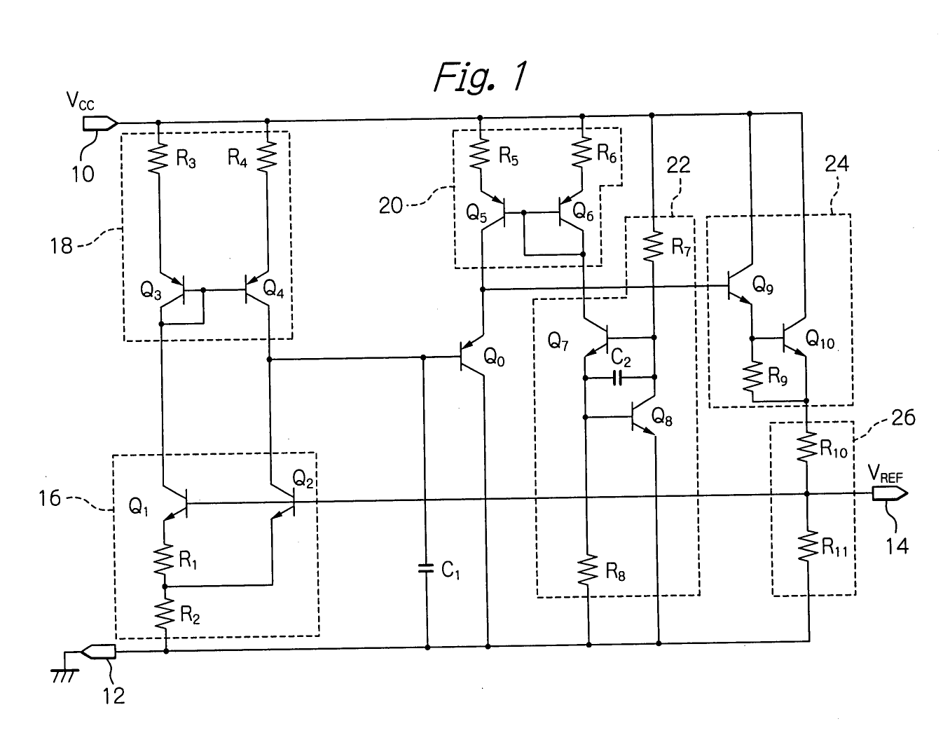

Before descriptions of an embodiment of the present invention, for better understanding of the present invention, a first prior art band-gap type constant voltage generating circuit will be explained with reference to FIG. 1.

This band-gap type constant voltage generating circuit is produced in a semiconductor chip (not shown), and is provided with a maximum potential terminal 10 to which a source voltage V_{CC} is applied, a minimum potential terminal 12 which is grounded, and an output terminal 14 from which a constant voltage V_{REF} is output.

As shown in FIG. 1, the constant voltage generating circuit includes a band-gap circuit 16, a current mirror circuit 18 for driving the band-gap circuit 16, a PNP type bipolar transistor Q₀ serving as an input transistor for receiving a voltage signal from the band-gap circuit 16, a current mirror circuit 20 for driving the input transistor Q₀, a current source circuit 22 for feeding a bias current to the current mirror circuit 20, a voltage level shift circuit 24 for receiving an emitter voltage signal from the input transistor Q₀, and a voltage divider circuit 26 for dividing a voltage from the voltage level shift circuit 24 to produce the constant voltage V_{REF}.

In particular, the band-gap circuit 16 has two NPN type bipolar transistors Q₁ and Q₂, and two resistors R₁ and R₂. The bases of the transistors Q₁ and Q₂ are connected to each other, and are then connected to the output terminal 14 to receive the constant voltage V_{REF} from the voltage divider circuit 26 as a feedback signal. The emitter of the transistor Q₁ is connected to the minimum potential terminal 12 through the resistors R₁ and R₂ connected in series to each other, and the emitter of the transistor Q₂ is connected to the minimum potential terminal 12 through the resistor R₂. Note, in reality, the transistors Q₁ and Q₂ are of a common-base type.

The current mirror circuit 18 has two PNP type bipolar transistors Q₃ and Q₄, and two resistors R₃ and R₄. Both the transistors Q₃ and Q₄ are formed as common-base type transistors. The collector of the transistor Q₃ forms an input terminal of the current mirror circuit 18, and both the collector and the base of the transistor Q₃ are connected to the collector of the transistor Q₁ of the band-gap circuit 16. The collector of the transistor Q₄ forms an output terminal of the current mirror circuit 18, and is connected to the collector of the transistor Q₁, to thereby drive the band-gap circuit 16. The emitters of the transistors Q₃ and Q₄ are connected to the maximum potential terminal 10 through the respective resistors R₃ and R₄.

The base of the input transistor Q₀ is connected to the collector of the transistor Q₂ of the band-gap circuit 16, and receives a collector voltage of the transistor Q₂ as the aforesaid voltage signal. As shown in FIG. 1, the base of the input transistor Q₀ is connected to the minimum potential terminal 12 through a capacitor C₁, and the collector of the input transistor Q₀ is connected to the minimum potential terminal 12.

The current mirror circuit 20 has two PNP type bipolar transistors Q₅ and Q₆, and two resistors R₅ and R₆. Both the transistors Q₅ and Q₆ are formed as common-base type transistors. The collector of the transistor Q₅ forms an output terminal of the current mirror circuit 20, and is connected to the emitter of the input transistor Q₀. The collector of the transistor Q₆ forms an input terminal of the current mirror circuit 20, and both the collector and the base of the transistor Q₆ are connected to each other. The emitters of the transistors Q₅ and Q₆ are connected to the maximum potential terminal 10 through the respective resistors R₅ and R₆.

The current source circuit 22 has two NPN type bipolar transistors Q₇ and Q₈, a capacitor C₂, and two resistors R₇ and R₈. The collector of the transistor Q₇ is connected to the input terminal of the mirror current circuit 20, i.e. the collector of the transistor Q₆. The emitter of the transistor R₇ is connected to the base of the transistor Q₈, and is then connected to the minimum potential terminal 12 through the resistor R₈. Also, the emitter of the transistor R₇ is connected to the collector of the transistor Q₈ through the capacitor C₂. The collector of the transistor Q₈ is connected to the base of the transistor Q₇, and is then connected to the maximum potential terminal 10 through the resistor R₇. Also, the emitter of the transistor Q₈ is connected to the minimum potential terminal 12. Thus, the bias current is fed from the collector of the transistor Q₇ to the collector of the transistor Q₆, to thereby drive the current mirror circuit 20.

The voltage level shift circuit 24 is formed as a Darlington circuit having two NPN type transistors Q₉ and Q₁₀, and a resistor R₉. The emitter of the transistor Q₉ is connected to the base of the transistor Q₁₀, and is then connected to the emitter of the transistor Q₁₀ through the resistor R₉. Namely, each of the transistors Q₉ and Q₁₀ serves as an emitter follower. The collectors of the transistors Q₉ and Q₁₀ are connected to the maximum potential terminal 10. The base of the transistor Q₉ is connected to the emitter of the input transistor Q₀, to thereby receive the emitter voltage signal from the emitter of the input transistor Q₀.

The voltage divider circuit 26 has two resistors R₁₀ and R₁₁ connected in series to each other. One end of the resistor R₁₀ is connected to the emitter of the transistor Q₁₀, and the other end of the resistor R₁₀ is connected to one end of the resistor 11, with the other end of the resistor 11 being connected to the minimum potential terminal 12. A voltage, output from the emitter of the transistor Q₁₀, is divided by the resistors R₁₀ and R₁₁ and a divided voltage produced between the resistors R₁₀ and R₁₁ is output as the constant voltage V_{REF} from the output terminal 14.

In short, the transistor Q₁₀, the current mirror circuit 20, the current source circuit 22, the voltage level shift circuit 24, and the voltage divider circuit 26 form a constant voltage production circuit for producing and outputting the constant voltage V_{REF} based on a base-emitter voltage produced in the transistor Q₂ of the band-gap circuit 16.

Note, each, of the capacitors C₁ and C₂ serves as a phase-compensating capacitor for eliminating vibrations which may be involved in the band-gap constant voltage generating circuit by feeding the feedback signal (V_{REF}) from the voltage divider circuit 26 to the band-gap circuit 16.

In this first prior art constant voltage generating circuit, when the base-emitter voltage of the transistor Q₂ is defined as V_{BE}(Q₂), and when a current flowing through the resistor R₂ is defined as I(R₂), the constant voltage V_{REF} is represented by the following equation:
V_{REF}=V_{BE}(Q₂)+R₂·I(R₂) (1)
Note, reference R₂ per se represents a resistance value of the resistor R₂.

Since the current I(R₂) is the sum of a current flowing through the resistor R₁ and an emitter current of the transistor Q₂, the equation (1) may be transformed as follows:
V_{REF}=V_{BE}(Q₂)+R₂[I(R₁)+I_{E}(Q₂)] (2)
Herein: I(R₁) represents the current flowing through the resistor R₁; and I_{E}(Q₂) represents the emitter current of the transistor Q₂. Note, reference R₁ per se represents a resistance value of the resistor R₁.

In order to further develop the equation (2), the emitter current I_{E}(Q₂) of the band-gap circuit 16 is analyzed and determined as explained below.

First, an emitter current of the transistor Q₁ is equal to the current I(R_{I}). Namely,
I_{E}(Q₁)=I(R₁)
Herein: I_{E}(Q₁) represents the emitter current of the transistor Q₁.

Also, when respective collector and base currents of the transistor Q₁ are defined as I_{C}(Q₁) and I_{B}(Q₁), the collector current I_{C}(Q₁) is represented by as follows:
I_{C}(Q₁)=I_{E}(Q₁)−I_{B}(Q₁) (3)
Herein: I_{C}(Q₁) and I_{B}(Q₁) represent the respective collector and base currents of the transistor Q₁.

Since the collector of the transistor Q₁ of the band-gap circuit 16 is connected to the input terminal of the current mirror circuit 18 (i.e., the collector of the transistor Q₃), an output current of the current mirror circuit 18 (i.e., the collector current of the transistor Q₄) is represented by using base currents of the transistors Q₃ and Q₄ as follows:
I_{C}(Q₄)=I_{C}(Q_{L})−I_{B}(Q₄)−I_{B}(Q₃) (4)
Herein: I_{C}(Q₄) and I_{B}(Q₄) represent the respective collector and base currents of the transistor Q₄; and I_{B}(Q₃) represents the base current of the transistor Q₃.

Since the collector of the transistor Q₄ is connected to the collector of the transistor Q₂, a collector current of the transistor Q₂ is equal to the collector current I_{C}(Q₄) of the transistor Q₄. Namely,
I_{C}(Q₂)=I_{C}(Q₄) (5)
Herein: I_{C}(Q₂) represents the collector current of the transistor Q₂. Note, a base current of the input transistor Q₀ is negligible.

Since the emitter current I_{E}(Q₂) of the transistor Q₂ of the band-gap circuit 16 is equal to an addition of a base current of the transistor Q₂ to the collector current I_{C}(Q₂) of the transistor Q₂, it is represented by the following equation:
I_{E}(Q₂)=I_{C}(Q₂)+I_{B}(Q₂) (6)
Herein: I_{B}(Q₂) represents the base current of the transistor Q₂.

Thus, by using the equations (5), (4) and (3) in order, the equation (6) may be transformed as follows:

$$\begin{matrix}{I}_{E} ( {Q}_{2} ) = {I}_{C} ( {Q}_{4} ) + {I}_{B} ( {Q}_{2} ) \\ = {I}_{C} ( {Q}_{1} ) - {I}_{B} ( {Q}_{4} ) - {I}_{B} ( {Q}_{3} ) + {I}_{B} ( {Q}_{2} ) \\ = {I}_{E} ( {Q}_{1} ) - {I}_{B} ( {Q}_{1} ) - {I}_{B} ( {Q}_{4} ) - {I}_{B} ( {Q}_{3} ) + {I}_{B} ( {Q}_{2} )\end{matrix} \qquad ( 7 )$$

Accordingly, the aforesaid equation (2) may be rewritten as follows:
V_{REF}=V_{BE}(Q₂)+R₂[2·I(R₁)−I_{B}(Q₁)−I_{B}(Q₄)−I_{B}(Q₃)+I_{B}(Q₂)] (8)

In the band-gap circuit 16, when a base-emitter voltage of the transistor Q₁ is defined as V_{BE}(Q₁), the current I(R₁) is represented by using the base-emitter voltages V_{BE}(Q₁) and V_{BE}(Q₂) of the transistors Q₁ and Q₂ as follows:
I(R₁)=[V_{BE}(Q₁)−V_{BE}(Q₂)]/R₁ (9)

When the difference [V_{BE}(Q₁)−V_{BE}(Q₂)] is defined as dV_{BE}, the equation (8) may be transformed by using the equation (9) as follows:

$$\begin{matrix}{V}_{REF} = {V}_{BE} ( {Q}_{2} ) + 2 \cdot {R}_{2} \cdot I ( {R}_{1} ) - {R}_{2} [ {I}_{B} ( {Q}_{1} ) + \\ {I}_{B} ( {Q}_{4} ) + {I}_{B} ( {Q}_{3} ) - {I}_{B} ( {Q}_{2} ) ] \\ = {V}_{BE} ( {Q}_{2} ) + 2 \cdot {R}_{2} [ {V}_{BE} ( {Q}_{1} ) - {V}_{BE} ( {Q}_{2} ) ] / {R}_{1} - \\ {R}_{2} [ {I}_{B} ( {Q}_{1} ) + {I}_{B} ( {Q}_{4} ) + {I}_{B} ( {Q}_{3} ) - {I}_{B} ( {Q}_{2} ) ] \\ = {V}_{BE} ( {Q}_{2} ) + 2 \cdot {R}_{2} \cdot {dV}_{BE} / {R}_{1} - {R}_{2} [ {I}_{B} ( {Q}_{1} ) + {I}_{B} ( {Q}_{4} ) + \\ {I}_{B} ( {Q}_{3} ) - {I}_{B} ( {Q}_{2} ) ]\end{matrix} \qquad ( 10 )$$

As already stated hereinbefore, the various elements forming the band-gap type constant generating circuit are subjected to both an absolute process fluctuation (±20%) and a relative process fluctuation (±2%) due to variation in the process conditions under which the band-gap type constant generating circuit is processed and produced.

In this connection, when examining and considering the equation (10), it is found that the first member V_{BE}(Q₂) is influenced by the absolute process fluctuation (±20%), the second member 2·R₂·dV_{BE}/R₁ is influenced by the relative process fluctuation (±2%), and the third member R₂[I_{B}(Q₁)+I_{B}(Q₄)+I_{B}(Q₃)−I_{B}(Q₂)] is influenced by the absolute process fluctuation (±20%). Especially, since the third member includes the sub-members I_{B}(Q₁), I_{B}(Q₄), I_{B}(Q₃) and I_{B}(Q₂) based on the respective base currents of the NPN type and PNP type bipolar transistors Q₁, Q₂, Q₃ and Q₄, the influence of the absolute process fluctuation (±20%) on the third member is considerably large.

Accordingly, the aforesaid first prior art band-gap type constant voltage generating circuit features inferior quality and reliance.

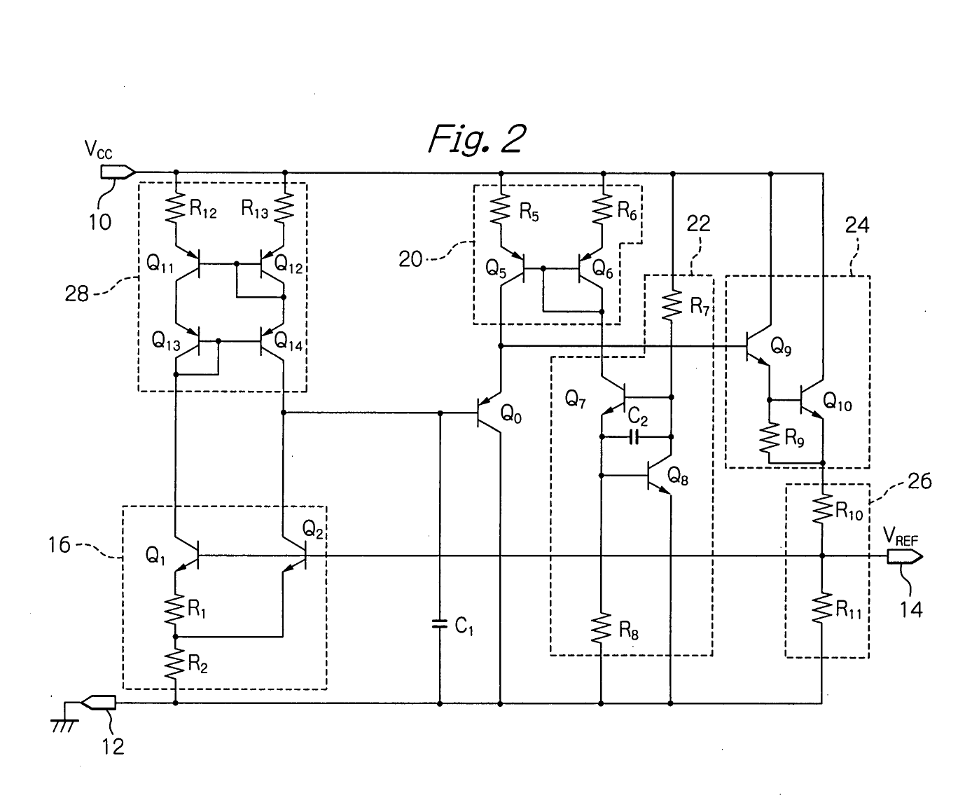

Next, a second prior art band-gap type constant voltage generating circuit will be explained with reference to FIG. 2.

This second prior art band-gap type constant voltage generating circuit is also produced in a semiconductor chip, and is substantially identical to the first prior art band-gap type constant voltage generating circuit except that a Wilson type current mirror circuit 28 is substituted for the current mirror circuit 18. Note, in FIG. 2, the same references as in FIG. 1 represent the same features.

As shown in FIG. 2, the Wilson type current mirror circuit 28 has four PNP type bipolar transistors Q₁₁, Q₁₂, Q₁₃ and Q₁₄, and two resistors R₁₂ and R₁₃. Both the transistors Q₁₁ and Q₁₂ are formed as common-base type transistors, and both the transistors Q₁₃ and Q₁₄ are formed as common-base type transistors. The emitters of the transistors Q₁₁ and Q₁₂ are connected to the maximum potential terminal 10 through the respective resistors R₁₂ and Q₁₃. The collector of the transistor Q₁₁ is connected to the emitter of the transistor Q₁₃. The collector of the transistor Q₁₃ forms an input terminal of the Wilson type current mirror circuit 28, and both the collector and the base of the transistor Q₁₃ are connected to the collector of the transistor Q₁ of the band-gap circuit 16, to thereby drive the band-gap circuit 16. Both the collector and the base of the transistor Q₁₂ are connected to the emitter of the transistor Q₁₄. The collector of the transistor Q₁₄ forms an output terminal of the Wilson type current mirror circuit 28, and is connected to the collector of the transistor Q₂ of the band-gap circuit 16.

In the Wilson type current mirror circuit 28, since the base current of each of the PNP type bipolar transistors Q₁₁, Q₁₂, Q₁₃ and Q₁₄ can be regarded as substantially zero, the collector currents I_{C}(Q₁) and I_{C}(Q₂) of the transistors Q₁ and Q₂ of the band-gap circuit 16 are equal to each other (I_{C}(Q₁)=I_{C}(Q₂)), and thus the base currents I_{B}(Q₁) and I_{B}(Q₂) of the transistors Q₁ and Q₂ are also equal to each other ((I_{C}(Q₁) I_{C}(Q₂)).

Accordingly, the emitter current I_{E}(Q₂) of the transistor Q₂ is equal to the current I(R₁) as shown in the following equation:
I_{E}(Q₂)=I_{C}(Q₂)+I_{B}(Q₂)=I_{C}(Q₁)+I_{B}(Q₁)=I(R₁)

Therefore, in the second prior art band-gap type constant voltage generating circuit, the constant voltage V_{REF} is represented by the following equation:

$$\begin{matrix}{V}_{REF} = {V}_{BE} ( {Q}_{2} ) + {R}_{2} [ I ( {R}_{1} ) + {I}_{E} ( {Q}_{2} ) ] \\ = {V}_{BE} ( {Q}_{2} ) + 2 \cdot {R}_{2} \cdot I ( {R}_{1} ) \\ = {V}_{BE} ( {Q}_{2} ) + 2 \cdot {R}_{2} [ {V}_{BE} ( {Q}_{1} ) - {V}_{BE} ( {Q}_{2} ) ] / {R}_{1} \\ = {V}_{BE} ( {Q}_{2} ) + 2 \cdot {R}_{2} \cdot {dV}_{BE} / {R}_{1}\end{matrix} \qquad ( 11 )$$

The equation (11) corresponds to the aforesaid equation (10), from which the third member R₂[I_{B}(Q₁)+I_{B}(Q₄)+I_{B}(Q₃)−I_{B}(Q₂)] is removed.

Accordingly, in the second prior art band-gap type constant voltage generating circuit, it is possible to eliminate the influence of the absolute process fluctuation (±20%), based on the base currents of the NPN type and PNP type bipolar transistors (Q₁, Q₂, Q₁₃ and Q₁₄), from the output constant voltage V_{REF}.

Nevertheless, the equation (11) still includes the first member V_{BE}(Q₂) influenced by the absolute process fluctuation (±20%). Thus, it is impossible to use the second prior art band-gap type constant voltage generating circuit to feed a reference voltage to a high precise comparator, in which fluctuation of several percent is required in the reference voltage.

The present invention aims at completely eliminating the influence of the absolute process fluctuation (±20%) from the output constant voltage V_{REF} in the aforesaid prior art band-gap type constant voltage generating circuits.

First Embodiment

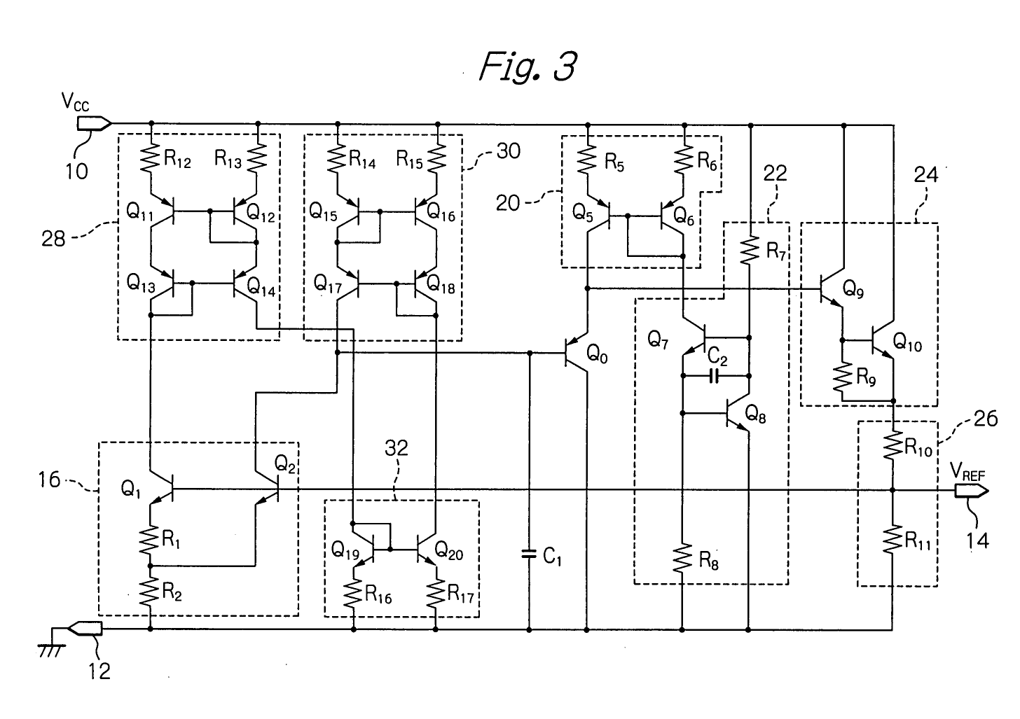

With reference to FIG. 3, a first embodiment of a band-gap type constant voltage generating circuit according to the present invention will be now explained below.

As is apparent from FIG. 3, the first embodiment corresponds to the second prior art band-gap type constant voltage generating circuit to which a Wilson type current mirror circuit 30 and a current mirror circuit 32 are added. Note, in FIG. 3, the same references as in FIG. 2 represent the same features.

In the second prior art band-gap type constant voltage generating circuit shown in FIG. 2, the Wilson type current mirror circuit 28 is provided for driving the band-gap circuit 16. However, in the first embodiment shown in FIG. 3, the band-gap circuit 16 is driven by the Wilson type current mirror circuits 28 and 30 and the current mirror circuit 32. Namely, the Wilson type current mirror circuits 28 and 30 and the current mirror circuit 32 form a driver circuit for the band-gap circuit 16.

The Wilson type current mirror circuit 30 has four PNP type bipolar transistors Q₁₅, Q₁₆, Q₁₇ and Q₁₈, and two resistors R₁₄ and R₁₅. Both the transistors Q₁₅ and Q₁₆ are formed as common-base type transistors, and both the transistors Q₁₇ and Q₁₈ are formed as common-base type transistors. The emitters of the transistors Q₁₄ and Q₁₅ are connected to the maximum potential terminal 10 through the respective resistors R₁₄ and Q₁₅. Both the collector and the base of the transistor Q₁₅ are connected to the emitter of the transistor Q₁₇. The collector of the transistor Q₁₇ forms an output terminal of the Wilson type current mirror circuit 30, and is connected to the collector of the transistor Q₂, to thereby drive the band-gap circuit 16. The collector of the transistor Q₁₆ is connected to the emitter of the transistor Q₁₈. The collector of the transistor Q₁₈ forms an output terminal of the Wilson type current mirror circuit 30, and both the collector and the base of the transistor Q₁₅ are connected to each other.

The current mirror circuit 32 has two PNP type bipolar transistors Q₁₉ and Q₂₀, and two resistors R₁₆ and R₁₇. Both the transistors Q₁₉ and Q₂₀ are formed as common-base type transistors. The emitters of the transistors Q₁₉ and Q₂₀ are connected to the minimum potential terminal 12 through the respective resistors R₁₆ and R₁₇. The collector of the transistor Q₁₉ forms an input terminal of the current mirror circuit 32, and both the collector and the base of the transistor Q₁₉ are connected to the output terminal of the Wilson type current mirror circuit 28 (i.e., the collector of the transistor Q₁₄) to thereby drive the current mirror circuit 32. The collector of the transistor Q₁₉ forms an output terminal of the current mirror circuit 32, and is connected to the input terminal of the Wilson type current mirror circuit 30 (i.e., the collector of the transistor Q₁₈) to thereby drive the Wilson type current mirror circuit 30.

Similar to the above-mentioned prior art band-gap constant voltage generating circuit, in the first embodiment of the present invention, the constant voltage V_{REF} is determined by a base-emitter voltage of the transistor Q₂ and a current flowing through the resistor R₂. Namely, the constant voltage V_{REF} is represented by the following equation:
V_{REF}=V_{BE}(Q₂)+R₂·I(R₂) (12)
Herein: V_{BE}(Q₂) represents the base-emitter voltage of the transistor Q₂; and I(R₂) represents the current flowing through the resistor R₂. Note, reference R₂ per se represents a resistance value of the resistor R₂.

Since the current I(R₂) is the sum of a current flowing through the resistor R₁ and an emitter current of the transistor Q₂, the equation (12) may be transformed as follows:
V_{REF}=V_{BE}(Q₂)+R₂[I(R₁)+I_{E}(Q₂)] (13)
Herein: I(R₁) represents the current flowing through the resistor R₁; and I_{E}(Q₂) represents the emitter current of the transistor Q₂. Note, reference R₁ per se represents a resistance value of the resistor R₁.

In order to further develop the equation (13), the emitter current I_{E}(Q₂) is analyzed and determined as explained below.

First, an emitter current of the transistor Q₁ is equal to the current I(R₁). Namely,
I_{E}(Q₁)=I(R₁) (14)
Herein: I_{E}(Q₁) represents the emitter current of the transistor Q₁.

Also, when respective collector and base currents of the transistor Q₁ are defined as I_{C}(Q₁) and I_{B}(Q₁), the collector current I_{C}(Q₁) is represented by as follows:
I_{C}(Q₁)=I_{E}(Q₁)−I_{B}(Q₁) (15)

Herein: I_{C}(Q₁) and I_{B}(Q₁) represent the respective collector and base currents of the transistor Q₁.

Since the collector of the transistor Q₁ of the band-gap circuit 16 is connected to the input terminal of the Wilson type current mirror circuit 28 (i.e., the collector of the transistor Q₁₃), an output current of the Wilson type current mirror circuit 28 (i.e., a collector current of the transistor Q₁₄) is equal to the collector current I_{C}(Q₁) of the transistor Q₁. Namely,
I_{C}(Q₁₄)=I_{C}(Q₁) (16)
Herein: I_{C}(Q₁₄) represents the collector of the transistor Q₁₄.

Since the collector of the transistor Q₁₄ is connected to the collector of the transistor Q₁₉ of the current mirror circuit 32, an output current of the current mirror circuit 32 (i.e., a collector current of the transistor Q₂₀) is smaller than the collector current I_{C}(Q₁₄) of the transistor Q₁₄ by the sum of base currents of the transistors Q₁₉ and Q₂₀. Namely, the collector current of the transistor Q₂₀ is represented by the following equation:
I_{C}(Q₂₀)=I_{C}(Q₁₄)−I_{B}(Q₁₉)−I_{B}(Q₂₀) (17)
Herein: I_{C}(Q₂₀) represents the collector current of the transistor Q₂₀; and I_{B}(Q₁₉) and I_{B}(Q₂₀) represent the respective base currents of the transistors Q₁₉ and Q₂₀.

Since the collector of the transistor Q₂₀ is connected to the input terminal of the Wilson type current mirror circuit 30 (i.e., the collector of the transistor Q₁₈), an output current of the Wilson type current mirror circuit 30 (i.e., a collector current of the transistor Q₁₇) is equal to the collector current I_{C}(Q₂₀) of the transistor Q₂₀ of the current mirror circuit 32. Namely,
I_{C}(Q₁₇)=I_{C}(Q₂O) (18)
Herein: I_{C}(Q₁₇) represents the collector current of the transistor Q₁₇.

Since the collector of the transistor Q₁₇ is connected to the collector of the transistor Q₂ of the band-gap circuit 16, a collector current of the transistor Q₂ is equal to the collector current I_{C}(Q₁₇) of the transistor Q₁₇ provided that a base current of the input transistor Q₀ is negligible. Namely,
I_{C}(Q₂)=I_{C}(Q₁₇) (19)
Herein: I_{C}(Q₂) represents the collector current of the transistor Q₂.

When a base current of the transistor Q₂ of the band-gap circuit 16 is defined as I_{B}(Q₂), the emitter current I_{E}(Q₂) of the transistor Q₂ is equal to the sum of the collector and base currents I_{C}(Q₂) and I_{B}(Q₂) of the transistor Q₂. Namely,
I_{E}(Q₂)=I_{C}(Q₂)+I_{B}(Q₂) (20)

Thus, the equation (20) may be transformed by using the equations (19), (18), (17), (16), (15) and (14) in order as follows:

$$\begin{matrix}{I}_{E} ( {Q}_{2} ) = {I}_{C} ( {Q}_{17} ) + {I}_{B} ( {Q}_{2} ) \\ = {I}_{C} ( {Q}_{20} ) + {I}_{B} ( {Q}_{2} ) \\ = {I}_{C} ( {Q}_{14} ) - {I}_{B} ( {Q}_{19} ) - {I}_{B} ( {Q}_{20} ) + {I}_{B} ( {Q}_{2} ) \\ = {I}_{C} ( {Q}_{1} ) - {I}_{B} ( {Q}_{19} ) - {I}_{B} ( {Q}_{20} ) + {I}_{B} ( {Q}_{2} ) \\ = {I}_{E} ( {Q}_{1} ) - {I}_{B} ( {Q}_{1} ) - {I}_{B} ( {Q}_{19} ) - {I}_{B} ( {Q}_{20} ) + {I}_{B} ( {Q}_{2} ) \\ = I ( {R}_{1} ) - {I}_{B} ( {Q}_{1} ) - {I}_{B} ( {Q}_{19} ) - {I}_{B} ( {Q}_{20} ) + {I}_{B} ( {Q}_{2} )\end{matrix} \qquad ( 21 )$$

When size ratios of the transistors Q₁, Q₂, Q₁₉ and Q₂₀ (i.e., ratios of the emitter junction areas of these transistors) are 1:1:1:1, the base currents I_{B}(Q₁), I_{B}(Q₂), I_{B}(Q₁₉) and I_{B}(Q₂₀) can be regarded as being equal to each other, because the respective base currents are sufficiently small in comparison with the collector currents of the transistors Q₁, Q₂, Q₁₉ and Q₂₀. Note, in general, an NPN type bipolar transistor features a base current (I_{B}(Q₁), I_{B}(Q₂), I_{B}(Q₁₉), I_{B}(Q₂₀)) which is in a range from 1/30 to 1/200 of a collector current thereof.

Thus, when each of the base I_{B}(Q₁), I_{B}(Q₂), I_{B}(Q₁₉) and I_{B}(Q₂₀), which can be regarded as being equal to each other, is defined as I_{B}, the equation (21) may be transformed as follows:
I_{E}(Q₂)=I(R₁)−2·I_{B} (22)

Accordingly, by using the equation (22), the aforesaid equation (13) may be rewritten as follows:

$$\begin{matrix}{V}_{REF} = {V}_{BE} ( {Q}_{2} ) + {R}_{2} [ I ( {R}_{1} ) + I ( {R}_{1} ) - 2 \cdot {I}_{B} ] \\ = {V}_{BE} ( {Q}_{2} ) + 2 \cdot {R}_{2} [ I ( {R}_{1} ) - {I}_{B} ]\end{matrix} \qquad ( 23 )$$

In the band-gap circuit 16, when a base-emitter voltage of the transistor Q₁ is defined as V_{BE}(Q₁), the current I(R₁) is represented by using the base-emitter voltages V_{BE}(Q₁) and V_{BE}(Q₂) of the transistors Q₁ and Q₂ as follows:
I(R₁)=[V_{BE}(Q₁)−V_{BE}(Q₂)]/R₁ (24)

When the difference [V_{BE}(Q₁)−V_{BE}(Q₂)] is defined as dV_{BE}, the equation (23) may be transformed by using the equation (24) as follows:

$$\begin{matrix}{V}_{REF} = {V}_{BE} ( {Q}_{2} ) + 2 \cdot {R}_{2} [ I ( {R}_{1} ) - {I}_{B} ] \\ = {V}_{BE} ( {Q}_{2} ) + 2 \cdot {R}_{2} [ [ {V}_{BE} ( {Q}_{1} ) - {V}_{BE} ( {Q}_{2} ) ] / {R}_{1} - {I}_{B} ] \\ = {V}_{BE} ( {Q}_{2} ) + [ 2 \cdot {R}_{2} / {R}_{1} ] {dV}_{BE} - 2 \cdot {R}_{2} \cdot {I}_{B}\end{matrix} \qquad ( 25 )$$

In the first embodiment shown in FIG. 3, the collector currents of the transistors Q₁, Q₂, Q₁₉ and Q₂₀ can be regarded as being equal to each other. Thus, when each of the collector currents of the transistors Q₁, Q₂, Q₁₉ and Q₂₀ is defined as I_{C}, the following relationship is established between the collector current I_{C} and the base current I_{B}:
I_{C}=h_{fe}·I_{B} (26)
Herein: h_{fe} represents a current amplification factor of the transistors Q₁, Q₂, Q₁₉ and Q₂₀.

Accordingly, by using the equation (26), the equation (25) may be further transformed as follows:
V_{REF}=V_{BE}(Q₂)+[2·R₂/R₁]dV_{BE}·2·R₂·I_{C}/h_{fe} (27)

In general, in a transistor (Q₁, Q₂, Q₁₉, Q₂₀), there is a linear inversely proportional relationship between a current amplification factor (h_{fe}) and a base-emitter voltage. Thus, it is possible to suitably set the resistance value R₂ and the collector current I_{C} such that the following equation is established:
V_{BE}(Q₂)=2·R₂·I_{C}/h_{fe} (28)

Namely, when the establishment of the equation (28) is carried by suitably setting the resistance value R₂ and the collector current I_{c}, the first member V_{BE}(Q₂) influenced by the absolute process fluctuation (±20%) can be removed from the equation (27). Thus, it is possible to completely eliminate the influence of the absolute process fluctuation (±20%) from the output constant voltage V_{REF} in the band-gap type constant voltage generating circuit shown in FIG. 3.

Second Embodiment

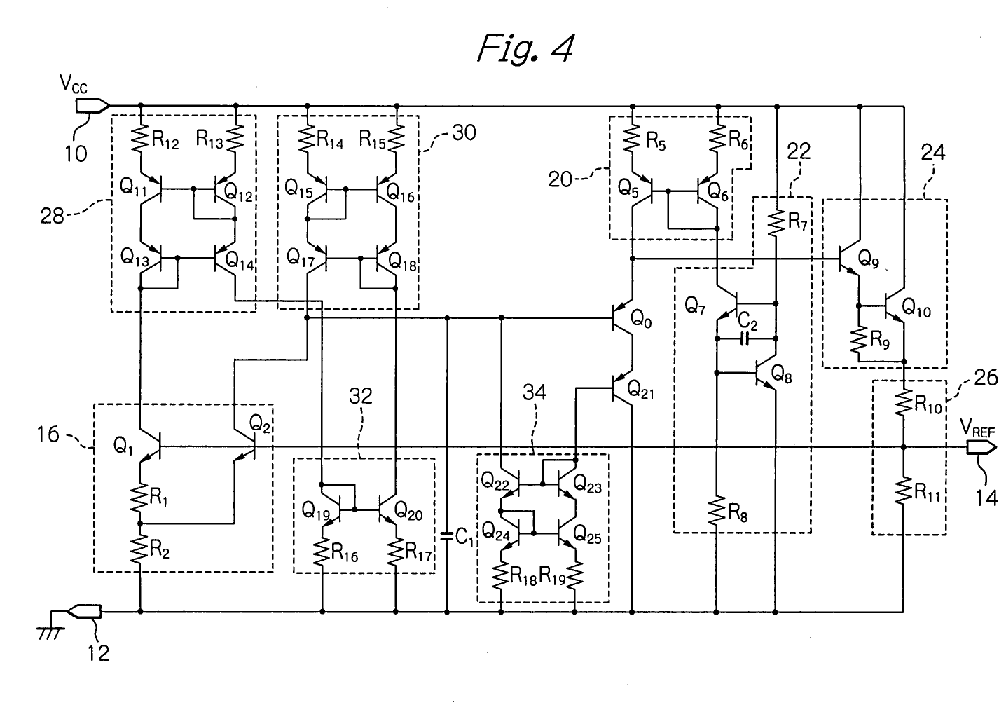

With reference to FIG. 4, a second embodiment of the band-gap type constant voltage generating circuit according to the present invention will be now explained below.

As is apparent from FIG. 4, the second embodiment corresponds to the first embodiment to which a PNP type bipolar transistor Q₂₁ and a Wilson type current mirror circuit 34 are further added. Note, in FIG. 4, the same references as in FIG. 3 represent the same features.

In the above-mentioned first embodiment, although an influence, caused by the base current of the input PNP type bipolar transistor Q₀, is neglected, in this second embodiment, that influence is taken into consideration. Namely, the transistor Q₂₁ and the Wilson type current mirror circuit 34 are provided to eliminate the influence, caused by the base current of the input transistor Q₀, from the output constant voltage V_{REF}.

As is apparent from FIG. 4, the transistor Q₂₁ features the same polarity type as that of the input transistor Q₀, and is associated with the transistor Q₀ as an additional transistor. The emitter of the additional transistor Q₂₁ is connected to the collector of the input transistor Q₀, and the collector of the additional transistor Q₂₁ is connected to the minimum potential terminal 12.

The Wilson type current mirror circuit 34 has four NPN type bipolar transistors Q₂₂, Q₂₃, Q₂₄ and Q₂₅, and two resistors R₁₈ and R₁₉. Both the transistors Q₂₂ and Q₂₃ are formed as common-base type transistors, and both the transistors Q₂₄ and Q₂₅ are formed as common-base type transistors. The collector of the transistor Q₂₂ forms an output terminal of the Wilson type current mirror circuit 34, and is connected to the base of the input transistor Q₀. The collector of the transistor Q₂₃ forms an input terminal of the Wilson type current mirror circuit 34, and both the collector and the base of the input transistor Q₀ is connected to the base of the additional transistor Q₂₁. The emitter of the transistor Q₂₂ is connected to both the collector and the base of the transistor Q₂₄, and the emitter of the transistor Q₂₃ is connected to the collector of the transistor Q₂₅. Both the collectors of the transistors Q₂₄ and Q₂₅ are connected to the minimum potential terminal 12 through the respective resistors R₁₈ and R₁₉.

As stated above, in the second embodiment, the influence, caused by the base current of the input transistor Q₀, is taken into consideration. Thus, when the base current of the input transistor Q₀ is defined as I_{B}(Q₀), the emitter current I_{E}(Q₂) of the transistor Q₂ Of the band-gap circuit 16 is represented by the following equation:

$$\begin{matrix}{I}_{E} ( {Q}_{2} ) = {I}_{C} ( {Q}_{2} ) + {I}_{B} ( {Q}_{2} ) \\ = {I}_{C} ( {Q}_{17} ) + {I}_{B} ( {Q}_{0} ) + {I}_{B} ( {Q}_{2} ) \\ = {I}_{C} ( {Q}_{20} ) + {I}_{B} ( {Q}_{0} ) + {I}_{B} ( {Q}_{2} ) \\ = {I}_{C} ( {Q}_{14} ) - {I}_{B} ( {Q}_{19} ) - {I}_{B} ( {Q}_{20} ) + {I}_{B} ( {Q}_{0} ) + {I}_{B} ( {Q}_{2} ) \\ = {I}_{C} ( {Q}_{1} ) - {I}_{B} ( {Q}_{19} ) - {I}_{B} ( {Q}_{20} ) + {I}_{B} ( {Q}_{0} ) + {I}_{B} ( {Q}_{2} ) \\ = {I}_{E} ( {Q}_{1} ) - {I}_{B} ( {Q}_{1} ) - {I}_{B} ( {Q}_{19} ) - {I}_{B} ( {Q}_{20} ) + {I}_{B} ( {Q}_{0} ) + {I}_{B} ( {Q}_{2} ) \\ = I ( {R}_{1} ) - {I}_{B} ( {Q}_{1} ) - {I}_{B} ( {Q}_{19} ) - {I}_{B} ( {Q}_{20} ) + {I}_{B} ( {Q}_{0} ) + {I}_{B} ( {Q}_{2} )\end{matrix} \qquad ( 29 )$$

Similar to the above-mentioned first embodiment, the base currents I_{B}(Q₁), I_{B}(Q₂), I_{B}(Q₁₉) and I_{B}(Q₂₀) can be regarded as being equal to each other. Thus, when each of the base I_{B}(Q₁), I_{B}(Q₂) I_{B}(Q₁₉) and I_{B}(Q₂₀) is defined as I_{B}, the equation (29) may be transformed as follows:
I_{E}(Q₂)=I(R₁)−2·I_{B}+I_{B}(Q₀) (30)

Accordingly, in the second embodiment, by using the equations (13), (24) and (30), the output constant voltage V_{REF} is represented by the following equation:
V_{REF}=V_{BE}(Q₂)+[2·R_{Z}/R₁]dV_{BE}−R₂[2·I_{B}−I_{B}(Q₀)] (31)

The transistors Q₀ and Q₂₁ feature substantially the same characteristic as each other, and thus collector currents of the transistors Q₀ and Q₂₁ can be regarded as being equal to each other. Namely, when the respective collector currents of the transistors Q₀ and Q₂₁ are defined as I_{C}(Q₀) and I_{C}(Q₂₁), I_{C}(Q₀)=I_{C}(Q₂₁). Also, when respective base currents of the transistors Q₀ and Q₂₁ are defined as I_{B}(Q₀) and I_{B}(Q₂₁), the base currents I_{B}(Q₀) (=I_{C}(Q₀)/h_{fe}) and I_{B}(Q₂₁) (=I_{C}(Q₂₁)/h_{fe}) are substantially equal to each other.

As already stated, since the base of the additional transistor Q₂₁ is connected to the input terminal of the Wilson type current mirror circuit 34 (i.e., the collector of the transistor Q₂₃), a collector current of the transistor Q₂₂, is equal to a base current of the additional transistor Q₂₁. Namely, when the collector current of the transistor Q₂₂ and the base current of the additional transistor Q₂₁ are defined as I_{C}(Q₂₂) and I_{B}(Q₂₁), respectively, the following relationship is established:
I_{B}(Q₀)=I_{B}(Q₂₁)=I_{C}(Q₂₂)

Thus, since the base current I_{B}(Q₀) of the transistor Q₀ flows into the collector of the transistor Q₂₂ without feeding into the collector of the transistor Q₂, the members I_{B}(Q₀) are canceled from the aforesaid equation (29). Accordingly, the equation (31) is transformed as follows:
V_{REF}=V_{BE}(Q₂)+[2R₂/R₁]dV_{BE}−2·R₂I_{B} (32)

Similar to the above-mentioned first embodiment, the equation (32) may be transformed as follows:
V_{REF}=V_{BE}(Q₂)+[2·R₂/R₁]dV_{BE}−2·R₂I_{C}/h_{fe} (33)

Accordingly, it is possible to suitably set the resistance value R₂ and the collector current I_{C} such that the following equation is established:
V_{BE}(Q₂)=2·R₂·I_{C}/h_{fe} (34)

Namely, when the establishment of the equation (34) is carried by suitably setting the resistance value R₂ and the collector current I_{C}, the first member V_{BE}(Q₂) influenced by the absolute process fluctuation (±20%) can be removed from the equation (33). Thus, it is possible to completely eliminate the influence of the absolute process fluctuation (±20%) from the output constant voltage V_{REF} in the band-gap type constant voltage generating circuit shown in FIG. 4.

Although the equation (32) is identical to the equation (25) obtained in the first embodiment, these equations (32) and (25) should be distinguished from each other, because the base current I_{B}(Q₀) of the input transistor Q₀ is neglected in the equation (25), whereas the base current I_{B}(Q₀) of the input transistor Q₀ is canceled in the equation (32). Namely, although the influence, caused by the base current of the input transistor Q₀, is merely neglected in the first embodiment, that influence is completely eliminated from the output constant voltage V_{REF} in this second embodiment.

Third Embodiment

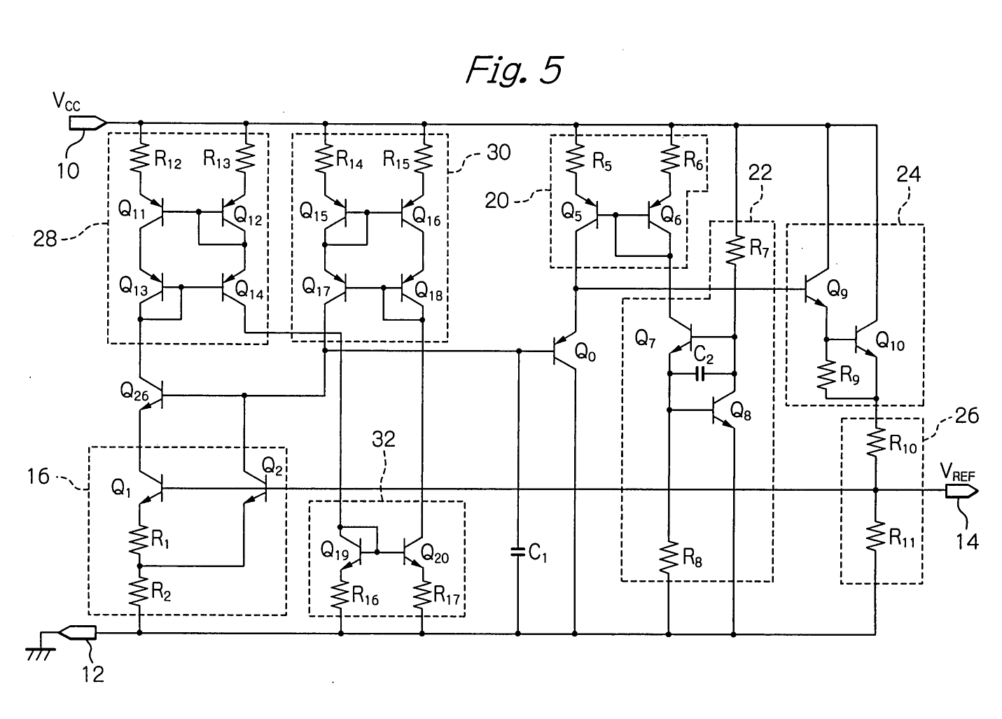

With reference to FIG. 5, a third embodiment of the band-gap type constant voltage generating circuit according to the present invention will be now explained below.

As is apparent from FIG. 5, the third embodiment corresponds to the first embodiment to which an NPN type bipolar transistor Q₂₆ is further added. Note, in FIG. 5, the same references as in FIG. 3 represent the same features.

In particular, the transistor Q₂₆ features the same polarity type as that of the transistors Q₁ and Q₂ of the band-gap circuit 16. The collector of the transistor Q₂₆ is connected to the input terminal of the Wilson type current mirror circuit 26 (i.e., the collector of the transistor Q₁₃), the base of the transistor Q₂₆ is connected to the collector of the transistor Q₂, and the emitter of the transistor Q₂₆ is connected to the collector of the transistor Q₁.

In this third embodiment, the output constant voltage V_{REF} is represented by the following equation:

$$\begin{matrix}{V}_{REF} = {V}_{BE} ( {Q}_{2} ) + [ 2 \cdot {R}_{2} / {R}_{1} ] {dV}_{BE} - α \cdot {R}_{2} \cdot {I}_{B} \\ = {V}_{BE} ( {Q}_{2} ) + [ 2 \cdot {R}_{2} / {R}_{1} ] {dV}_{BE} - α \cdot {R}_{2} \cdot {I}_{C} / {h}_{fe}\end{matrix} \qquad ( 25 )$$

Herein: α is a coefficient which is determined in dependence upon a size of the transistor Q₂₆, i.e. an emitter junction area of the transistor Q₂₆.

For example, when the emitter junction area of the transistor Q₂₆ is equal to those of the transistors Q₁, Q₂) Q₁₉ and Q₂₀, a base current of the transistor Q₂₆ may be regarded as I_{B}. In this case, the coefficient α is determined as 1. By suitably regulating the emitter junction area of the transistor Q₂₆, it is possible to optionally determine the coefficient α. Namely, the transistor Q₂₆ serves as a coefficient-determination transistor for determining the coefficient α.

Similar to the first embodiment, in the third embodiment, before the first member V_{BE}(Q₂) influenced by the absolute process fluctuation (±20%) can be removed from the equation (35), it is necessary to set the resistance value R₂ and the collector current I_{C} such that the following equation is established:
V_{BE}(Q₂)=α·R₂·I_{C}/h_{fe} (36)

According to the third embodiment, freedom of the settings of the resistance value R₂ and the collector current I_{C} can be considerably improved in comparison with the first embodiment, because it is possible to optionally determine the coefficient α by suitably regulating the emitter junction area of the coefficient-determination transistor Q₂₆.

In the first embodiment, there may be a case where the settings of the resistance value R₂ and the collector current I_{C} for establishing the equation (28) cannot be carried out. In this case, a coefficient of the third member R₂·I_{C}/h_{fe} of the equation (27) can be varied by regulating an emitter junction area ratio of the transistors Q₁₉ and Q₂₀ of the current mirror circuit 32, so that the settings of the resistance value R₂ and the collector current I_{C} is made possible.

For example, in the first embodiment, when the transistor Q₂₀ features an emitter junction area twice as large as that of the transistor Q₁₉, the aforesaid equation (17) is modified as follows:
I_{C}(Q₂₀)=I_{C}(Q₁₄)−I_{B}(Q₁₉)−2·I_{B}(Q₂₀)
Also, the aforesaid equation (27) is modified as follows:
V_{REF}=V_{BE}(Q₂)+[2·R₂/R₁]dV_{BE}−4·R₂·I_{C}/h_{fe}
Namely, when the emitter junction area of the transistor Q₂₀ is twice as large as that of the transistor Q₁₉, the coefficient of the third member R₂·I_{C}/h_{fe} of the equation 27 is changed from 2 to 4.

Although the settings of the resistance value R₂ and the collector current I_{C} for establishing the equation (28), i.e. V_{BE}(Q₂)=2·R₂·I_{C}/h_{fe}, are impossible, there may be a case where the resistance value R₂ and the collector current I_{C} can be set such that the equation (V_{BE}(Q₂)=4·R₂·I_{c}/h_{fe}) is established.

Note, the coefficient-determination transistor Q₂₆ may be added to the second embodiment shown in FIG. 4, to thereby vary a coefficient of the third member R₂·I_{C}/h_{fe} of the equation (33).

In order to evaluate the present invention, first and second simulation tests were performed with respect to the first, second and third embodiments and the second prior art constant voltage generating circuit (FIG. 2) by the inventors.

In the first simulation test, it was supposed that a current amplification factor (h_{fe}) of each of the NPN type transistors Q₁, Q₂, Q₁₉ and Q₂₀ has been subjected to absolute process fluctuations of +20%, and that the resistance value R₂ has been subjected to absolute process fluctuations of ±20%. A device influenced by the absolute process fluctuations of ±20% was defined as an H-product; a device not influenced by the absolute process fluctuations (0%) was defined as an M-product; and a device influenced by the absolute process fluctuations of −20% was defined as an L-product. Also, in the first simulation test, a potential of 7 volts was applied to the maximum potential terminal 10, and a potential of the minimum potential terminal 12 was zero volts.

The second simulation test was identical to the first simulation test except that a potential of 8 volts was applied to the maximum potential terminal 10.

The results of the first and second simulation tests are shown in the following table:

VARIATION IN OUTPUT CONSTANT VOLTAGE V_{REF}

| | 1^{st} | | 2^{nd} | | 3^{rd} | | 2^{nd} | |
|---|---|---|---|---|---|---|---|---|
| | EMBODIMENT | | EMBODIMENT | | EMBODIMENT | | PRIOR ART | |
| MAX. P | 7 V | 8 V | 7 V | 8 V | 7 V | 8 V | 7 V | 8V |
| H-P | 1.209 V | 1.216 V | 1.207 V | 1.214 V | 1.192 V | 1.196 V | 1.234 V | 1.251 V |
| M-P | 1.215 V | 1.221 V | 1.211 V | 1.217 V | 1.198 V | 1.201 V | 1.219 V | 1.227 V |
| L-P | 1.223 V | 1.227 V | 1.213 V | 1.217 V | 1.199 V | 1.201 V | 1.224 V | 1.229 V |
| Δ | 0.014 V | 0.011 V | 0.006 V | 0.003 V | 0.007 V | 0.005 V | 0.015 V | 0.024 V |

As is apparent from this table, for example, in the first embodiment (FIG. 3), when the potential of 7 volts was applied to the maximum potential terminal 10, a constant voltage V_{REF} output from the H-product (H-P) was 1.209 volts; a constant voltage V_{REF} output from the M-product (M-P) was 1.215 volts; and a constant voltage V_{REF} output from the L-product (L-P) was 1.223 volts. In this case, a difference A between the minimum constant voltage V_{REF} (1.209 V) output from the H-product and the maximum constant-voltage V_{REF} (1.223 V) output from the L-product was 0.014 volts.

Also, in the first embodiment (FIG. 3), when the potential of 8 volts was applied to the maximum potential terminal 10, a constant voltage V_{REF} output from the H-product (H-P) was 1.216 volts; a constant voltage V_{REF} output from the M-product (M-P) was 1.221 volts; and a constant voltage V_{REF} output from the L-product (L-P) was 1.227 volts. In this case, a difference Δ between the minimum constant voltage V_{REF} (1.216 V) output from the H-product and the maximum constant voltage V_{REF} (1.227 V) output from the L-product was 0.011 volts.

In the second embodiment (FIG. 4), when the potential of 7 volts was applied to the maximum potential terminal 10, a difference A between the minimum constant voltage V_{REF} (1.207 V) output from the H-product and the maximum constant voltage V_{REF} (1.213 V) output from the L-product was 0.006 volts. Also, when the potential of 8 volts was applied to the maximum potential terminal 10, a difference A between the minimum constant voltage V_{REF} (1.214 V) output from the H-product and the maximum constant voltage V_{REF} (1.217 V) output from the L-product was 0.003 volts.

In the third embodiment (FIG. 5), when the potential of 7 volts was applied to the maximum potential terminal 10, a difference A between the minimum constant voltage V_{REF} (1.192 V) output from the H-product and the maximum constant voltage V_{REF} (1.199 V) output from the L-product was 0.007 volts. Also, when the potential of 8 volts was applied to the maximum potential terminal 10, a difference Δ between the minimum constant voltage V_{REF} (1.196 V) output from the H-product and the maximum constant voltage V_{REF} (1.201 V) output from the L-product was 0.005 volts.

On the other hand, in the second prior art constant voltage generating circuit (FIG. 2), when the potential of 7 volts was applied to the maximum potential terminal 10, a difference Δ between the minimum constant voltage V_{REF} (1.219 V) output from the M-product and the maximum constant voltage V_{REF} (1.234 V) output from the H-product was 0.015 volts. Also, when the potential of 8 volts was applied to the maximum potential terminal 10, a difference A between the minimum constant voltage V_{REF} (1.227 V) output from the M-product and the maximum constant voltage V_{REF} (1.251 V) output from the L-product was 0.024 volts.

In short, as is apparent from the above table, according to the present invention, it is found that the variation in the output constant voltage V_{REF} is considerably small.

Finally, it will be understood by those skilled in the art that the foregoing description is of preferred embodiments of the device, and that various changes and modifications may be made to the present invention without departing from the spirit and scope thereof.

1. A band-gap type constant voltage generating circuit produced in a semiconductor chip and having a first potential terminal and a second potential terminal, which circuit comprises:
a band-gap circuit including first and second transistors having respective bases connected to each other, a first resistor connected between emitters of said first and second transistors, and a second resistor connected between the emitter of said second transistor and said first potential terminal;
a constant voltage production circuit provided between said first and second potential terminals to produce and output a constant voltage based on a base-emitter voltage of the second transistor of said band-gap circuit, with the constant voltage being fed as a feedback signal to the base of the second transistor of said band-gap circuit; and
a driver circuit provided between said first and second potential terminals and connected to collectors of the first and second transistors to drive said band-gap circuit,
wherein said driver circuit is constituted such that an influence of absolute process fluctuation, to which said semiconductor chip is subjected during a production process thereof, is eliminated from said constant voltage.

2. The band-gap type constant voltage generating circuit as set forth in claim 1, wherein said driver circuit includes:
a current mirror circuit having an input terminal and an output terminal and connected to said first potential terminal;
a first Wilson type current mirror circuit having an input terminal and an output terminal and connected to said second potential terminal; and
a second Wilson type current mirror circuit having an input terminal and an output terminal and connected to said second potential terminal,
the respective collectors of the first and second transistors of said band-gap circuit being connected to the input terminal of said first Wilson type current mirror circuit and the output terminal of said second Wilson type current mirror circuit,
the respective input and output terminals of said current mirror circuit being connected to the output terminal of said first Wilson type current mirror circuit and the input terminal of said second Wilson type current mirror circuit.

3. The band-gap type constant voltage generating circuit as set forth in claim 2, wherein said current mirror circuit includes third and fourth transistors having respective bases connected to each other, a third resistor connected between said first potential terminal and an emitter of said third transistor, and a fourth resistor connected between said first potential terminal and an emitter of said fourth resistor, a collector of said third transistor forming the input terminal of said current mirror circuit, a collector of said fourth transistor forming the output terminal of said current mirror circuit.

4. The band-gap type constant voltage generating circuit as set forth in claim 3, wherein said constant voltage is represented by the following equation:
V_{REF}=V_{BE}(Q₂)+[2·R₂/R₁]dV_{BE}−2·R₂·I_{C}/h_{fe}
herein: V_{REF} is said constant voltage; V_{BE}(Q₂) is the base-emitter voltage of said second transistor; R₂ is a resistance value of said second resistor; R₁ is a resistance value of said first resistor; dV_{BE} is a difference between a base-emitter voltage of said first transistor and the base-emitter voltage of said second transistor; I_{C} is a collector current of said first, second, third and fourth transistors; and h_{fe} is a current amplification factor of said first, second, third and fourth transistors,
said resistance value R₂ and said collector current I_{C} being set such that the following equation is established:
V_{BE}(Q₂)=2·R₂·I_{C}/h_{fe}

5. The band-gap type constant voltage generating circuit as set forth in claim 4, wherein an emitter junction area ratio of the third and fourth transistors of said current mirror circuit is regulated to thereby vary the coefficient of the third member R₂·I_{C}/h_{fe} of said first-mentioned equation.

6. The band-gap type constant voltage generating circuit as set forth in claim 3, wherein there is provided a coefficient-determination-transistor between the collector of said first transistor of said band-gap circuit and the input terminal of said first Wilson type current mirror circuit, a collector of said coefficient-determination transistor being connected to the input terminal of said first Wilson type current mirror circuit, a base of said coefficient-determination transistor being connected to the collector of the second transistor of said band-gap circuit, an emitter of said coefficient-determination transistor being connected to the collector of the second transistor of said band-gap circuit, and wherein said constant voltage is represented by the following equation:
V_{REF}=V_{BE}(Q₂)+[2·R₂/R₁]dV_{BE}α·R₂·I_{C}/h_{fe}
herein: V_{REF} is said constant voltage; V_{BE}(Q₂) is the base-emitter voltage of said second transistor; R₂ is a resistance value of said second resistor; R₁ is a resistance value of said first resistor; dV_{BE} is a difference between a base-emitter voltage of said first transistor and the base-emitter voltage of said second transistor; I_{C} is a collector current of said first, second, third and fourth transistors; h_{fe} is a current amplification factor of said first, second, third and fourth transistors, and a is a coefficient determined in dependence upon an emitter junction area of said coefficient-determination transistor,
said resistance value R₂ and said collector current I_{C} being set such that the following equation is established:
V_{BE}(Q₂)=α·R₂·I_{C}/h_{fe}

7. The band-gap type constant voltage generating circuit as set forth in claim 6, wherein an emitter junction area ratio of the third and fourth transistors of said current mirror circuit is regulated to thereby vary the coefficient α of the third member R₂·I_{c}/h_{fe} of said first-mentioned equation.

8. The band-gap type constant voltage generating circuit as set forth in claim 4, wherein said constant voltage production circuit includes an input transistor having a base for receiving the base-emitter voltage of the second transistor of said band-gap transistor, and a transistor associated with said input transistor as an additional transistor, and a third Wilson type current mirror circuit are provided to thereby eliminate an influence, caused by a base current of said input transistor, from said first-mentioned equation.

9. The band-gap type constant voltage generating circuit as set forth in claim 8, wherein said third Wilson type current mirror circuit has an input terminal and an output terminal and is connected to said first potential terminal, the output and input terminals of said third Wilson type current mirror circuit being connected to the respective bases of said input and additional transistors, a collector of said input transistor being connected to an emitter of said additional transistor, a collector of said additional transistor being connected to said first potential terminal.

10. The band-gap type constant voltage generating circuit as set forth in claim 9, wherein an emitter junction area ratio of the third and fourth transistors of said current mirror circuit is regulated to thereby vary the coefficient of the third member R₂·I_{c}/h_{fe} of said first-mentioned equation.

11. The band-gap type constant voltage generating circuit as set forth in claim 6, wherein said constant voltage production circuit includes an input transistor having a base for receiving the base-emitter voltage of the second transistor of said band-gap transistor, and a transistor associated with said input transistor as an additional transistor, and a third Wilson type current mirror circuit are provided to thereby eliminate an influence, caused by a base current of said sixth transistor, from said equation.

12. The band-gap type constant voltage generating is circuit as set forth in claim 11, wherein said third Wilson type current mirror circuit has an input terminal and an output terminal and is connected to said first potential terminal, the output and input terminals of said third Wilson type current mirror circuit being connected to the respective bases of said input and additional transistors, a collector of said input transistor being connected to an emitter of said additional transistor, a collector of said additional transistor being connected to said first potential terminal.

13. The band-gap type constant voltage generating circuit as set forth in claim 12, wherein an emitter junction area ratio of the third and fourth transistors of said current mirror circuit is regulated to thereby vary the coefficient α of the third member R₂·I_{c}/h_{fe} of said first-mentioned equation.
